(19) United States
(12) Patent Application Publication
(10) Pub. No.: US 2009/0153807 A1
(43) Pub. Date: Jun. 18, 2009

(54) IMAGE PROJECTOR

(75) Inventor: Trevor Jackson, Kirtland, OH (US)

Correspondence Address: PATENT, COPYRIGHT & TRADEMARK LAW GROUP, 4199 Kinross Lakes Parkway, Suite 275, RICHFIELD, OH, 44286, US

(73) Assignee: Emerald Innovations, L.L.C, Butler, PA (US)

(21) Appl. No.: 11/869,257

(22) Filed: Oct. 9, 2007

Related U.S. Application Data
(60) Provisional application No. 60/828,624, filed on Oct. 6, 2006.

(51) Int. Cl. G03B 21/64; G03B 21/14

(52) U.S. Cl. 353/95; 353/119

(57) ABSTRACT

A projector having a housing containing an electrical light source, an image medium support aligned in the light path of the light source, and a lens through which light emanating from the light source exits the housing after passing through an image medium disposed in the image medium support.

### PRIORITY CLAIM

This application claims the benefit of U.S. Provisional Patent Application Ser. No. 60/828,624, entitled “IMAGE PROJECTOR” filed Oct. 6, 2006, the entire contents of which are incorporated herein by reference.

### SUMMARY

This disclosure relates to devices used to project images onto one or more surfaces by shining a light through a medium that includes an image. More particularly, this disclosure relates to projectors used to project thematic images, in either a static or serial display, onto a surface.

In accordance with one aspect of the image projector, an image projector is provided that includes a projector comprising a housing containing a directional electric light source, such as one or more incandescent, fluorescent or LED (light emitting diode) bulbs, a lens disposed opposite the light source, a light path extending from the light source through the lens and out of the housing, and an image medium support disposed between the light source and the lens that is adapted to support an image medium in the light path.

In accordance with another aspect of the image projector, an image projector is provided that includes an image medium support that is moveable relative to the lens to facilitate the focusing of the projected image. In accordance with another aspect of the image projector, an image projector is provided that includes a image medium holder that is adapted to receive a variety of image medium, including image medium that are created or customized by the user and formed from one or a combination of a variety of materials.

In accordance with another aspect of the image projector, an image projector is provided that includes a support that is attachable to the projector for supporting the projector on a surface. In one embodiment of the support, the support can be selectively chosen from at least a stand and a stake to allow the support to support the image projector on a variety of surfaces.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing summary and the following detailed description are exemplary and explanatory only and are not restrictive of the invention, as claimed. The accompanying drawings, which are incorporated in and constitute a part of this specification, illustrate several embodiments of the invention, and together with the description, serve to explain the principles of the invention.

### BRIEF DESCRIPTION OF THE DRAWINGS

The foregoing features of the present invention will become apparent to one skilled in the art to which the present invention relates upon consideration of the following description of the invention with reference to the accompanying drawings, in which:

FIG. 1 is a perspective view of the an exemplary embodiment of an image projector with the stand in the stowed state;

FIG. 2 is a perspective view of the image projector of FIG. 1 with the top cover removed;

FIG. 3 is a perspective view of the image projector of FIG. 1 with the housing removed;

FIG. 4A is a front view of an exemplary embodiment of an image medium holder in the open position;

FIG. 4B is a perspective view of the image medium holder in the closed position;

FIG. 5 is a top view of the image projector of FIG. 1;

FIG. 6 is a bottom view of the image projector of FIG. 1 with the stand in the closed and folded position;

FIG. 7 is a side elevational view of an exemplary embodiment of an image projector with the stand in the deployed state;

FIG. 8 is a front elevational view of the image projector of FIG. 1 with the stand in the deployed state;

FIG. 9 is a side elevational view of an additional embodiment of an image projector with a stake assembly; and

FIG. 10 is a side view of the stake assembly of FIG. 9, with the sleeve in an open position.

### DETAILED DESCRIPTION OF THE IMAGE PROJECTOR

This disclosure relates to devices used to project images onto one or more surfaces by shining a light through a medium that includes an image.

While various aspects and concepts of the image projector are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the image projector, such as alternative materials, structures, configurations, methods and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the image projector into additional embodiments within the scope of the present invention even if such embodiments are not expressly disclosed herein. Additionally, even though some features, concepts or aspects of the image projector may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

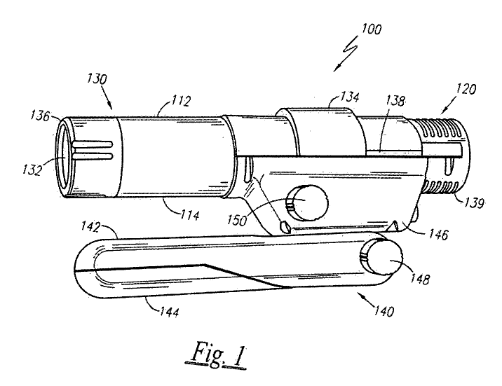

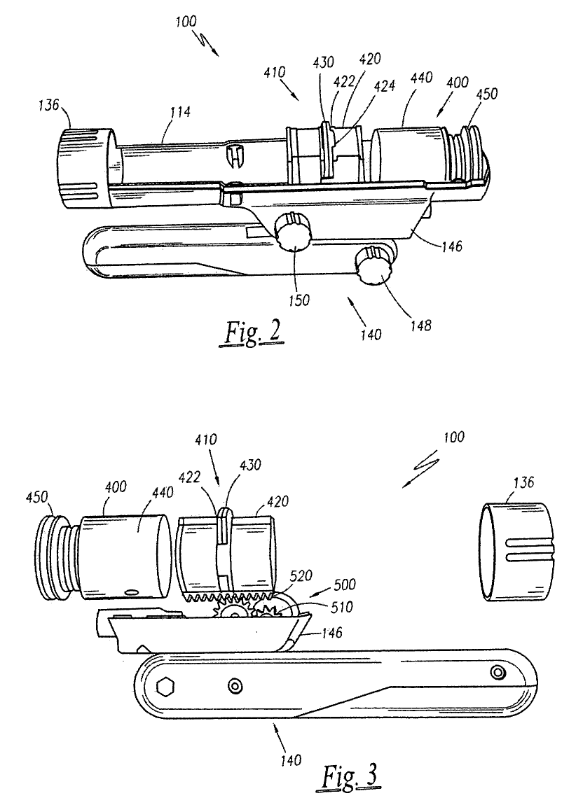

FIG. 1 illustrates an exemplary embodiment of an image projector in accordance with the present invention. In the exemplary embodiment illustrated in FIG. 1, the image projector 100 generally includes a housing 110 having a light source end 120 that is adapted to contain an electric light source 400 (as shown in FIG. 2) and a lens end 130 that is adapted to receive a lens 132. In various embodiments of the image projector 100, disposed within the housing 110 is an image medium support 410 (as shown in FIG. 2) positioned between the electric light source 400 and the lens 132. The image medium support 410 is adapted to support an image medium within the path of the light emanating from the electric light source 400 to facilitate the projection of the image located on the image medium onto a distant surface. An imaginary line between the electric light source 400, the supported image medium (described further herein) and the lens 132, when extended beyond the image projector 100, continues to a viewing surface upon which the image is to be projected.

The image medium comprises, in various embodiments, a material that is semi-transparent, transparent, or translucent, or combinations of these, and comprises one or more images, text, or patterns or combinations of these rendered thereon or therethrough, the patterns being regular or irregular, and in the form of shapes, prisms, or the like. According to some embodiments, the images may be thematic, and depict figures or patterns associated with a holiday, birthday, season or other event, or sports teams or other subject matter of interest. It will be understood that the subject matter and format of the image is not intended to be limiting. The image medium may be formed of any suitable material such as polymeric sheets or films, cellulose film, and films or sheets made of natural fibers, such as paper or fabric. In some embodiments, the image medium is formed of or comprises polymeric film in the shape of a disc. In various embodiments of the image projector 100, the image medium may be customizable by a user of the image projector 100. In such embodiments, the user may customize or create an image medium having any image, text, and/or pattern that the user desires.

The housing 110 of the illustrated embodiment of the image projector 100 includes a top cover 112 and a bottom cover 114. The housing 110 may be of a unitary construction, or it may have more than two pieces, or it may have a variety of other constructions or configurations. While the housing 110 of the embodiment illustrated in FIG. 1 has a generally cylindrical shape, the housing 110 is not limited to this shape and can have a variety of different shapes in additional embodiments. The housing 110 of the illustrated embodiment is molded from plastic, but a variety of other suitable natural or synthetic materials may also be used. The top cover 112 and bottom cover 114 are adapted to be assembled together using screws, snaps, sonic welding, glue or other fasteners that are known in the art. In additional embodiments, the top cover 112 and bottom cover 114 (or other pieces of the housing 110) may be attached in a manner that allows the top cover 112 and bottom cover 114 to move relative to one another. The top cover 112 and bottom cover 114 are adapted to support and enclose other components of the image projector 100.

An opening 700 (as shown in FIG. 5) is defined within the top cover 112 of the exemplary embodiment of the image projector 100 to provide access to the interior of the housing 110. The opening 700 provides access to the image medium support 410 that is disposed within the interior of the housing 110 to permit the cleaning, alteration, modification, repair, replacement, insertion, removal and/or adjustment of the image medium mounted within the image medium support. In additional embodiments, the image projector 100 could also be provided with one or more openings defined within the housing 110 that provide access to the lens 132 for the cleaning, repair, adjustment or replacement of the lens, and/or the light source 400 for the cleaning, repair, adjustment or replacement of the bulb or other portion of the light source 400. In additional embodiments, any of the openings described above may include a seal to further ensure the prevention of the entry of water or other debris into the interior of the housing 110. Finally, it should be understood that additional embodiments of image projector 100 may be sealed and be provided without any opening into the interior of the housing 110 of the image projector.

Referring to the embodiment of the image projector 100 shown in FIG. 1, the opening 700 is covered by a panel 134. Among other things, when in the closed position, the panel 134 serves to prevent dirt, dust, water, or other matter from entering the interior of the housing 110. The panel 134 of the exemplary embodiment is slidable between an open position and a closed position on a track 138 defined within the housing 110. However, it should be understood that the panel 134 could be configured differently, for example the panel 134 could pivot on a hinge or rotate about a central axis. The panel 134 of the exemplary embodiment is formed of translucent plastic to permit visibility of the interior of the housing 110. However, it should be understood that the panel 134 could be fashioned from an opaque material in additional embodiments. In addition, the panel 134 could be formed from a variety of suitable materials in additional embodiments. Finally, it should be understood that additional embodiments of the image projector 100 may be provided without a panel 134.

As mentioned above, the lens 132 of the illustrated embodiment of the image projector 100 is disposed within the housing 110. Referring again to FIG. 1, the lens 132 of the illustrated embodiment is a generally circular shaped lens. The lens 132 of the exemplary embodiment is a plastic biconvex lens. However, additional embodiments of the image projector 100 are provided with a variety of different kinds of lenses. For example, the lens could be a plano-convex, convex-concave, meniscus, plano-concave, or biconcave lens. Additional embodiments of the image projector 100 are provided with a plurality of lenses that can be selectively installed and removed from the image projector 100 to achieve different effects as the users desires. Additional embodiments of the image projector 100 may also include two or more lenses that are used in combination with each other in series. The lens(es) can have a variety of different sizes and shapes, such as square, rectangular, triangular, oval, etc. The lens(es) can also be formed of a variety of suitable materials, such as transparent or translucent plastic or glass, or could be formed from two or more different materials that are bonded together (for example, two or more materials that have different refraction indexes).

Additional embodiments of the image projector 100 are provided with film or screens that are either adhered directly to the lens or disposed in front of the lens. For example, additional embodiments of the image projector 100 are provided with a colored translucent film or screen that is adhered directly to the lens(es) or disposed in front or behind the lens(es) to tint the light and/or image projected by the image projector 100. Also, additional embodiments of the image projector 100, the lens(es) are formed of shaped or patterned lenses, or prisms.

In various embodiments, the lens 132 or lenses are attached to the housing 110 in an irremovable fashion, while additional embodiments include a lens 132 or lenses that are attached to the housing 110 in a removable fashion, in order to receive replacement lenses. In various embodiments, the lens 132 or lenses are movable or adjustable to permit the adjustment of the focal length, while in other embodiments the lens 132 or lenses are not adjustable. Also, additional embodiments of the image projector 100 include lenses that may be driven to rotate, oscillate, spin, or otherwise move by a power source.

Again referring to FIG. 1, the illustrated embodiment of the image projector includes a lens ring 136. The lens ring 136 is a generally cylindrically shaped ring that is removably attached to the lens end 130 of the housing 110 via a threaded arrangement; however the lens ring 136 may also be attached to the housing 110 in a variety of ways, such as glue, screws, sonic welding, or another fastening means. While the lens 132 of the image projector 100 is mounted within the housing 110, in additional embodiments the lens 132 is disposed within the lens ring 136, which is in turn mounted to the housing 110. In various embodiments of the image projector 100, the lens ring 136 secures the lens 132 onto the housing 100. In various embodiments, the lens ring 136 serves to shield and protect the lens 132. In additional embodiments of the image projector 100, the lens ring 136 includes a flange that projects forward beyond the lens 132 to further shield and protect the lens 132. It should be understood that additional embodiments of the image projector 110 may be provided without such a lens ring 136.

As mentioned above, an electrical light source 400 is disposed within the light source end 120 of the housing 110. In various embodiments, the electrical light source 400 includes one or more electric lamps or bulbs. Referring now to FIG. 2, the electrical light source 400 includes a light emitting diode (LED) bulb (not shown). While the LED bulb included with the embodiment illustrated in FIG. 2 is a 3 Watt LED bulb, which provides high brightness while giving off little heat, other LED bulbs may be provided, the wattage of such bulbs being from 3, 4, 5, 6, 7, 8, 9, 10 Watts or greater.

Various additional embodiments of the image projector 100 are provided with bulbs or lamps that are incandescent or fluorescent. A variety of other types of bulbs or lamps may also be provided with additional embodiments, said bulbs being selected from a variety of wattages. The electric light source of the illustrated embodiment of the image projector 100 emits white light, but additional embodiments of the image projector include bulbs emitting a variety of colors. In various embodiments, the bulb is mounted within the housing 110 irremovably, while additional embodiments of the image projector 100 include bulbs that re removably mounted within the housing 110 to facilitate the replacement of the bulb. Additional embodiments of the image projector 100 are provided with two or more bulbs, having a variety of wattages, lumens, brightnesses, colors, etc., that can be selectively chosen by the user.

The electric light source 400 of the embodiment of the image projector 100 illustrated in FIG. 2 includes a reflector assembly 440. The reflector assembly 440 includes a reflector (not shown) for focusing, and/or directing the light emitted from the bulb of the light source 400. Additional embodiments of the image projector may be provided with a system of a plurality of one or more reflectors and/or one or more lenses for the purposes of directing, focusing, refracting, reflecting and/or intensifying the light emitted from the light source 400. Additional embodiments of the image projector 100 include a light source 400 that does not include a reflector assembly 440.

The light source 400 of the embodiment of the image projector 100 illustrated in FIG. 2 includes a heat sink 450 for dissipating the heat given off by the light source 400. Referring to FIG. 1, the exemplary embodiment of the image projector 100 includes a plurality of vents or louvers 139 defined within the housing 110 to facilitate convective cooling of the light source 400 during use. It should also be understood that additional embodiments of the image projector 100 are provided without such a heat sink and/or vents or louvers. In additional embodiments of the image projector 100, a fan, liquid cooling system, or other type of cooling system is provided for further cooling the light source 400 during use.

The exemplary embodiment of the image projector 100 includes appropriate wiring (not shown) for attaching the light source 400 to a power source. A variety of power sources may be provided with various embodiments of the image projector 100. The exemplary embodiment 100 of the image projector is powered by standard household current, 120 V. Electrical cords, transformers, and plugs are also provided with various embodiments of the image projector 100 for connecting the image projector 100 to a power source. Various embodiments of the image projector 100 may be provided for indoor or outdoor use, or both. In certain embodiments, the image projector 100 is provided with appropriate power transformer capability, weatherproofing, and/or a ground fault circuit interrupter for outdoor use. Additional embodiments of the image projector are provided with a variety of power sources, such as rechargeable or non-rechargeable batteries or a battery pack or a direct current adapter.

As mentioned previously, an image medium support 410 is disposed within the housing 110 of the embodiment of the image projector 100 illustrated in FIG. 2. The image medium support 410 is adapted to support and hold an image medium within the housing in between the light source 400 and the lens 132 in a manner that permits light emitted from the light source 400 to pass through the image medium and onward through the lens 132. In this manner, the image set forth on the image medium is projected on a distant surface by the image projector 100.

The image medium support 410 may have any construction, shape or configuration that allows it to support an image medium between the light source 400 and the lens 132. The image medium support 410 includes an image medium carriage 420 that is adapted to support an image medium holder 430, which, in turn, holds the image medium. However, in additional embodiments of the image projector 100, the image medium support 410 does not include an image medium carriage 420 and/or an image medium holder 430. In various embodiments, the image medium support 410 is a multipart assembly, while in other embodiments, the image medium support is of a unitary, one-piece construction.

The image medium carriage 420 can have a variety of configurations and shapes. The image medium carriage 420 may have any shape or configuration that allows it to support the image medium holder 430 and/or an image medium. Referring again to FIG. 2, the image medium carriage 420 of the illustrated embodiment is a generally hollow, cylindrically shaped body disposed within the housing 110. The image medium carriage 420 of the exemplary embodiment is formed from plastic, although other suitable materials, such as metal, cardboard, or paper, may also be used. While the image medium carriage 420 of the embodiment of the image projector 100 illustrated in FIG. 2 is disposed entirely within the housing 110 of the image projector, various additional embodiments of the image projector 100 include image medium carriages 420 that are disposed partially within the housing and extend outside the housing 110 or are located entirely outside of the housing 110.

The image medium carriage 420 of the embodiment illustrated in FIG. 2 has an image medium holder slot 422 defined within it. The image medium holder slot 422 can have a variety of shapes and configurations. The image medium holder slot 422 can have any shape or configuration that allows it to receive and hold the image medium holder 430 and/or image medium. The image medium holder slot 422 has a generally rectangular shape when viewed from the top with an alignment notch 424 extending from the image medium holder slot 422. The alignment notch 424 serves to ensure that the image medium holder 430 and/or the image medium are properly oriented within the image medium carriage 420. The alignment notch 424 can have any shape and configuration that facilitates the alignment of the image medium holder 430 and/or image medium within the image medium carriage 420. It should be understood that all embodiments of the image projector 100 do not include such and alignment notch 424. In additional embodiments, the image medium carriage 420 has more than one image medium holder slot 422 to accommodate multiple image medium holders and/or image medium. Furthermore, it should be apparent that the shape of the slot and the type of medium that the slot can accommodate may vary.

The image medium carriage 420 illustrated in FIG. 2 is adapted to be selectively movable within the housing 110 to allow for adjustment of the distance between the image medium and the lens 132 so as to facilitate focusing the projected image. The movement of the image medium carriage 420 can be accomplished in a variety of different ways. The image medium carriage 420 can be either manually moved or moved by an automated device or assembly. In addition, it should be understood that additional embodiments of the image projector 100 include a stationary image medium carriage 420 that is not capable of movement.

As mentioned above, in various embodiments, the image medium carriage 420 is selectively movable by a movement mechanism. The movement mechanism can have a variety of constructions and configurations. A variety of manual devices and/or automated devices can serve as the movement mechanism in alternative embodiments of the image projector 100. Referring now to FIG. 3, the movement mechanism 500 of the illustrated embodiment is a rack and pinion assembly 500. The illustrated image projector 100 includes an image adjuster 150 in operative communication with the gear assembly 500. The image adjuster 150 is an adjustment knob 150 mounted on the housing 110. However, in additional embodiments of the image projector 100 that provide for the adjustment of the image medium, other adjustment devices, such as a slide, lever, adjustment wheel, etc. act as the image adjuster 150. The image adjuster 150 of the illustrated embodiment of the image projector drives a gear assembly 510 of the movement mechanism 500. The gear assembly 510, in turn, drives a rack 520 mounted to the underside of the image medium carriage 420. In this manner, the image medium carriage 420 and the image medium held within the image medium carriage 420 can be selectively repositioned by the user closer towards or farther from the lens 132 via the manipulation of the image adjuster 150. As mentioned previously, the movement mechanism can have a variety of configurations. For example, the rack 520 could be disposed on the housing 110 or other portion of the image projector 100 and the gear assembly or pinion 520 could be disposed on the image medium carriage 420. A variety of other devices, such as a screw assembly, gear assembly, manual slide or lever, etc. could serve as the movement mechanism 500. As mentioned previously, it should be understood that additional embodiments of the image projector 100 include a stationary image medium carriage 420 that is not capable of movement. And in yet other embodiments, the image projector 100 may include more than one image carriage 420 and movement mechanism.

The image medium holder 430 serves to hold and secure the image medium. The image medium holder 430 can have a variety of shapes and configurations. The image medium holder can have any shape or configuration that allows it to receive and hold an image medium. In various embodiments, the image medium holder 430 is a device that accommodates the removal and installation of a plurality of interchangeable image medium, while in other embodiments, the image medium holder 430 is static and includes one or more image medium that are permanently disposed within the image medium holder 430. In various embodiments, the image medium holder 430 is adjustable to accommodate image medium having a variety of thicknesses.

In embodiments of the image projector 100 that include an image medium support 410 or image medium holder 430 that accommodate interchangeable image medium that may be selectively installed within the image medium support 410 or image medium holder 430, the image medium may be a pre-made image medium that is either provided with the image projector 100 or separately purchased. Such pre-made image medium include a pre-determined image. For use with various embodiments of the image projector 100, the image medium may be customizable by a user of the image projector 100. In such embodiments, the user may customize or create an image medium having any image that the user desires. For example, the user may utilize a printer, such as a laser printer or ink-jet printer, to print an image onto a material that is semi-transparent, transparent, or translucent, or combinations of these. A user may select an image or text or a combination thereof from a collection of images located on an internet website, software program, dvd, cd-rom or other storage medium. Such customizable image medium may include either one or more images or text or a combination of text and image(s). In addition, such customizable image medium may also be created by a user by hand, using markers, pens, pencils, paint, ink, or some other method to create the image on a suitable image medium.

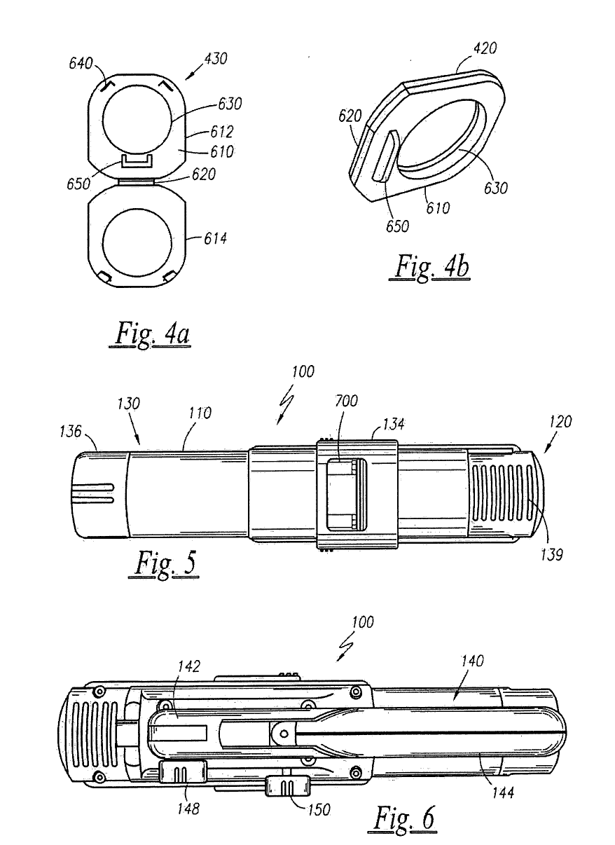

Referring now to FIGS. 4A-4B, the image medium holder 430 of the illustrated embodiment has a main body 610, which comprises two generally, identically shaped halves 612, 614 connected by a connection mechanism 620. A variety of devices can serve as the connection mechanism 620. The connection mechanism 620 of the illustrated embodiment of the image medium holder 430 is a hinge 620; however other devices, such as snaps, tabs, velcro, etc., can also be used. The hinge 620 of the illustrated embodiment is a living hinge formed from a flexible plastic, such as polypropylene or polyethylene, or other suitable material. However, it should be understood that other types of hinges could be used and not all embodiments of the image medium holder 430 include such a hinge 620.

An image medium window 630 is defined within each of the halves 612, 614 of the image medium holder 430. The image medium window 630 allows light emitted from the light source to pass through the image medium disposed with in the image medium holder 430. The image medium window 630 of the illustrated embodiment of the image medium holder 430 has a generally circular shapes, but other shapes can be used, such as triangular, rectangular, oval, etc. In various embodiments, a variety of screens, prisms, films or other devices may be disposed across the image medium window 630 that are selected to alter the projected image. The embodiment of the image medium holder 430 set forth in FIGS. 4A-4B includes a closure device 640. A variety of devices can serve as the closure device 640. The closure device 640 of the illustrated embodiment is a pair of locking tabs, but other devices, such as snaps, velcro, etc. can also be used. The image medium holder 430 of the embodiment illustrated in FIGS. 4A-4B includes an alignment tab 650 that is adapted to fit within the alignment slot 424 of the image medium carriage 420 to ensure that the image medium holder 430 is properly aligned within the image medium carriage 420. The alignment tab 650 can have any shape or configuration that serves to align the image medium holder 430. In addition, it should be understood, that additional embodiments of the image medium holder 430 are provided without such an alignment tab 650. The image medium holder 430 of the embodiment illustrated in FIGS. 4A-4B is adapted to receive pre-made image medium that are provided with the image projector 100 or separately purchased or image medium that has been either created or customized by the user of the image projector.

As mentioned previously, a variety of devices may serve as the image medium holder 430 in additional embodiments of the image projector 100. For example, a pair of glass or polymeric plates may be used to sandwich the image medium for insertion into the housing. The plates may be circular, square, or have some other shape. Accordingly, in such embodiments, the housing 110 or image medium support 410 is adapted to receive and support the plates that hold the image medium.

To use the embodiment of the image projector 100 illustrated in FIG. 1, the user inserts an image medium into the image medium holder 430 so that the image set forth on the image medium is disposed within the window 630 defined within the image medium holder 430. The image medium holder 430 is then inserted into the image medium holder slot 422 of the image medium carriage 420 via the opening 700 disposed within the housing 110. The alignment tab 650 of the image medium holder 430 engages with the alignment slot 424 to ensure that the image medium holder 430 is properly oriented within the image medium carriage 420.

Once the light source 400 is activated, the light emitted from the light source 400 passes through the image medium disposed within the image medium holder 430 held within the image medium carriage 420 and onwards through the lens 132. In this manner, the light emitted from the light source 400 projects the image set forth on the image medium onto a distant surface. The user may then utilize the image adjuster knob 150 to alter the distance between the image medium and the lens to facilitate the focusing of the projected image. If the user desires to change the image medium, the image medium holder 430 is removed from the image projector 100 and the image medium disposed within the image medium holder 430 can be exchanged for another image medium as the user desires. In addition, the image medium holder 430 can be removed from the image projector 100 and a separate and distinct image medium holder 430 including an image medium with a different image can be inserted into the image projector 100.

It should be understood that the various additional embodiments described herein are used and operated differently than the manner described in connection with the illustrated embodiment of the image projector 100 described above. For example, various embodiments of the image projector 100 do not provide for the interchanging of the image medium. Also, other embodiments of the image projector 100 do not provide for the adjustment of the projected image. Various additional embodiments of the image projector 100 contain a one-piece image medium support 410 that does not include an image medium carriage 420 or image medium holder 430. For example, various embodiments of the image projector 100 include only a image medium carriage 420 that directly receives the image medium. Yet other embodiments of the image projector may include a plurality of image medium, located on a disk or other collective image medium device, that are projected by the image projector in a cycle or series. The method of operation for such embodiments of the image projector 100 should be apparent to those skilled in the art.

In some embodiments, the projector comprises a support. The support may be integral with the projector 100 or separate from the projector 100 in various embodiments. The support may have any shape, configuration or construction that can support the image projector on a surface. In various embodiments, the support comprises means for supporting the projector onto a flat surface or for attachment to a wall, pole or other surface or structure.

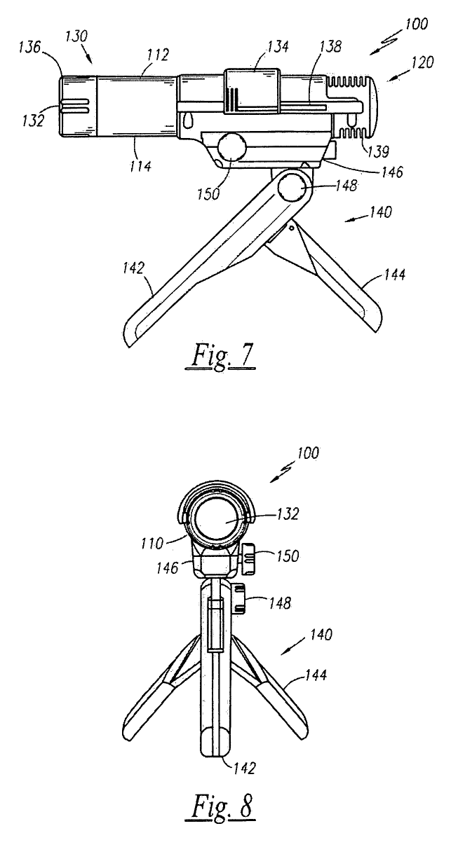

FIGS. 7-8 illustrate one possible embodiment of a support. The support of the embodiment of the image projector 100 depicted in FIGS. 7-8 comprises a support in the form of a three leg, collapsible stand 140 having a main leg 142 and a pair of secondary legs 144. The support 140 of the embodiment of the image projector depicted in FIGS. 7-8 is mounted to the projector 100 via a housing mount 146, but the support 140 may be attached to the image projector 100 in a variety of additional manners. The depicted support 140 is formed of plastic, metal or other suitable material and is collapsible by the compression and pivoting of the secondary legs 144 for folded insertion into the main leg 142. The support 140 illustrated in FIGS. 7-8 includes secondary legs that are movable between an open or deployed state (as shown in FIGS. 7-8) and a closed or stowed state (as shown in FIG. 1) and are biased into the deployed state by a spring (not shown). When in the open or deployed state, the secondary legs 144 form a three point support along with the main leg 142 to support the image projector 100. When in the closed or stowed state, the secondary legs are adapted to be partially received within the main leg 142 to form a single structure (as shown in FIG. 1). It should be understood that additional embodiments of the image projector are provided without such a collapsible support 140. Additional embodiments may have a static support 140 that is not capable of being folded down, or may be collapsed or folded in a different manner. Additional embodiments of the support 140 may have any number of support legs or support surfaces.

The support 140 of the embodiment of the image projector 100 depicted in FIGS. 7-8 is adjustable. The support 140 is adapted to pivot with respect to the image projector 100 to adjust the angle of the image projector with respect to the horizontal plane of the surface that it is supported upon. Additional embodiments of the support 140 of the image projector 100 may also be adapted to rotate with respect to image projector 100. A support adjustment 148 is provided with the embodiment of the image projector 100 depicted in FIGS. 7-8. The support adjustment 148 is a knob that can be selectively locked to lock the support 140 in place or can be unlocked to permit the adjustment of the support 140 with respect to the image projector 100. It should be understood that additional embodiments of the image projector do not include adjustable stands and do not provide such a support adjustment 148.

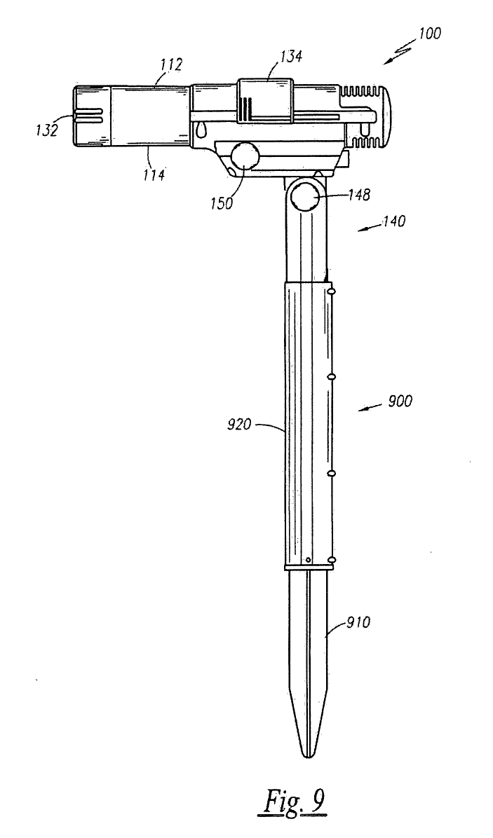

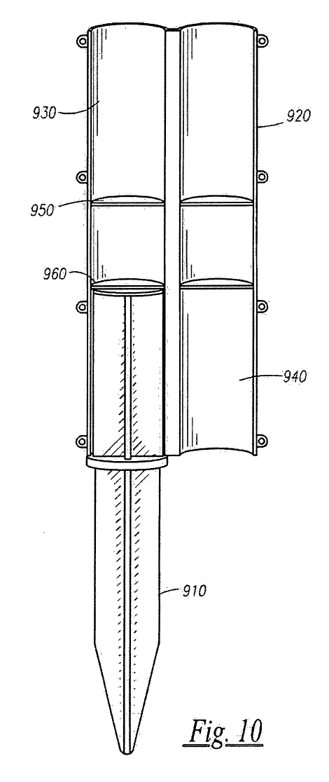

In alternate embodiments, the support 140 may include a stake or stake assembly 900 (as shown in FIG. 9) that can be driven into the ground or other appropriate support substrate. The stake assembly 900 depicted in FIG. 9 includes a stake 910 and a sleeve 920. As shown in FIG. 10, the sleeve 920 includes a stand receiver 930 with a stand support wall 950 and a stake receiver 940 with a stake support wall 960. The stake receiver 940 is adapted to receive the stake 910 with the end of the stake abutting the stake support wall 960. the stand receiver 930 is adapted to receive the stand 140, when in the folded position as described above, with the end of the stand 140 abutting the stand support wall 950. In this manner, the projector can be selectively supported upon the stand 140 or the stake assembly 900 depending upon the surface on which a user desires to support the image projector 100. When the image projector is supported with the stake assembly 900, the angle of the image projector 100 with respect to the stake assembly 900 may be adjusted by the use of the support adjustment 148 as described above. It should be understood that additional embodiments of the image projector include only a support stand 140 or only a stake or stake assembly 900. Finally, it should be understood that additional embodiments of the image projector 100 include alternate supports other than stands or stakes.

The image projector has been illustrated by the above description of embodiments, and while the embodiments have been described in some detail, it is not the intent of the applicants to restrict or in any way limit the scope of the invention to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicants' general or inventive concept. Other alterations and modifications of the image projector will likewise become apparent to those of ordinary skill in the art upon reading the present disclosure, and it is intended that the scope of the image projector disclosed herein be limited only by the broadest interpretation of the appended claims to which the inventors are legally entitled.

1. A projector comprising:
a directional light source, a lens, and an image medium support disposed therebetween;
wherein the image medium support is adapted to support at least one image medium between the light source and the lens so that light emitting from the light source passes through the image medium, through the lens, and out of the housing; and
a movement mechanism operatively connected with the image medium support, wherein via actuation of the movement mechanism the image medium support is adapted to be selectively movable with respect to the lens to permit the adjustment of the distance between the at least one image medium and the lens.

2. The projector of claim 1 wherein the image medium support comprises:
an image medium carriage; and
an image medium holder, wherein the image medium carriage is adapted to receive the image medium holder within an opening defined in the medium carriage, and wherein the image medium holder is adapted to receive at least one image medium.

3. The projector of claim 1 wherein the movement mechanism comprises a rack and pinion assembly.

4. The projector of claim 2 wherein the movement mechanism comprises a rack and pinion assembly.

5. The projector of claim 4 wherein the position of the image medium support with respect to the lens is adjusted by the manipulation of an adjustment knob that is operatively connected with the movement mechanism.

6. The projector of claim 2 wherein the image medium holder comprises first and second halves connected by a hinge.

7. The projector of claim 6 wherein the image medium holder is selectively movable between an open position and a closed position and is adapted to permit the insertion of an image medium into the image medium holder when in the open position and is adapted to secure the image medium when in the closed position, the image medium holder comprising on each of its halves an image window.

8. The projector of claim 2 further comprising an alignment mechanism adapted to ensure the image medium holder is correctly oriented within the image medium carriage.

9. The projector of claim 8 wherein the alignment mechanism comprises an alignment tab projecting from the image medium holder, the alignment tab being adapted to fit within an alignment slot defined within the image medium carriage

10. The projector of claim 1 wherein the light source comprises a light emitting diode bulb.

12. The projector of claim 1 further comprising:
a support for supporting the image projector on a surface, the support comprising
a stand, the stand having a deployed state and a stowed state; and
a stake assembly, the stake assembly adapted to receive the stand when the stand is in the stowed state; wherein the projector is adapted to be supported by the stand when the stand is in the deployed state and the projector is adapted to be supported by the stake assembly when the stand is in the stowed state and received within the stake assembly.

13. The projector of claim 12 wherein the stand comprises a main leg and a pair of secondary legs, the main leg being adapted to at least partially receive the secondary legs when the stand is in the stowed state.

14. The projector of claim 13 wherein the light source and the lens are each disposed within a housing.

15. The projector of claim 14 wherein the light source and the lens are each disposed within the same housing.

16. A projector comprising:
a directional light source and a lens;
a support for supporting the image projector on a surface, the support comprising
a stand, the stand having a deployed state and a stowed state; and
a stake assembly, the stake assembly adapted to receive the stand when the stand is in the stowed state; wherein the image projector is adapted to be supported by the stand when the stand is in the deployed state and the image projector is adapted to be supported by the stake assembly when the stand is in the stowed state and received within the stake assembly.

17. The projector of claim 16 wherein the stand comprises a main leg and a pair of secondary legs, the main leg being adapted to at least partially receive the secondary legs when the stand is in the stowed state.

18. The projector of claim 17 wherein the light source and the lens are each disposed within a housing.

19. The projector of claim 18 wherein the light source and the lens are each disposed within the same housing.

20. The projector of claim 19 further comprising:
an image medium support disposed between the light source and the lens, wherein the image medium support comprises;
an image medium carriage; and
an image medium holder, wherein the image medium carriage is adapted to receive the image medium holder within an opening defined in the medium carriage, and wherein the image medium holder comprises first and second halves connected by a hinge and is selectively movable between an open position and a closed position and is adapted to permit the insertion of at least one image medium into the image medium holder when in the open position and is adapted to secure the image medium when in the closed position, the image medium holder comprising on each of its halves an image window; and
a movement mechanism operatively connected with the image medium support, wherein via actuation of the movement mechanism the image medium support is adapted to be selectively movable with respect to the lens to permit the adjustment of the distance between the at least one image medium and the lens.
